(19) United States
(12) Patent Application Publication
(10) Pub. No.: US 2008/0017300 A1
(43) Pub. Date: Jan. 24, 2008

(54) Custom environmentally friendly multilayer restroom fixture decorative device

(75) Inventor: David Smith, Powell, OH (US)

Correspondence Address: GALLAGHER & DAWSEY CO., L.P.A., P.O. BOX 785, COLUMBUS, OH, 43216, US

(73) Assignee: Vinyl Targets, LLC

(21) Appl. No.: 11/479,398

(22) Filed: Jun. 30, 2006

(51) Int. Cl. G06F 9/44

(52) U.S. Cl. 156/235

(57) ABSTRACT

A method for making a custom environmentally friendly multilayer restroom fixture decorative device and the associated decorative device is provided. In one embodiment, the method includes uploading a graphic to a computer system having a graphics modification system. When the desired graphic is uploaded to the computer system with a graphics modification system, the graphics modification system is utilized to create a modified graphic. Next, the modified graphic is transmitted to a cutting device. After the modified graphic has been transmitted to the cutting device, the cutting device cuts the modified graphic from a pliable graphic substrate to create an appliqué. Finally, once the appliqué has been cut from the pliable graphic substrate, the appliqué is attached to a pliable backing substrate that includes a porcelain attachment surface having a releasable urine-resistant adhesive layer to releasably attach the pliable backing substrate to the interior of a restroom fixture.

### TECHNICAL FIELD

The instant invention relates to methods of making decorative devices, the associated devices, and more particularly to a method of making a decorative device for a restroom fixture, and the device, that is multilayered, customizable, and environmentally friendly to use.

### BACKGROUND OF THE INVENTION

It is well known that home dwellers and business establishments use decorative accents to make their homes and businesses more comfortable and aesthetically pleasing. The use of such items can serve to satisfy both decorative and functional needs in areas throughout homes and businesses. However, the restroom is often an overlooked area when it comes to the use of decorative accents. Moreover, restroom fixtures, such as toilets and urinals, typically receive less decorative attention with respect to the remaining areas of the restroom.

Restroom fixtures are typically thought of as functional furnishings rather than decorative furnishings. Many of the decorative devices for restroom fixtures are displayed on the fixture's exterior surfaces, such as decorative toilet tank covers and toilet seat lids. These types of decorative devices can become unsanitary and germ infested, requiring removal and cleaning. Another problem associated with decorative devices for restroom fixtures is that most devices are not specifically tailored to what a potential user desires. Thus, the potential user must choose from a fixed selection of decorative devices.

Therefore, an unfulfilled need remains to provide a decorative device that is customizable by a potential user and capable of being displayed on the interior water-contacting surface of a restroom fixture. Furthermore, there is a need to provide such a decorative device that is sanitary, easily cleanable and removable, and designed such that it will not add pollutants to wastewater streams.

### SUMMARY OF INVENTION

In its most general configuration, the present invention advances the state of the art with a variety of new capabilities and overcomes many of the shortcomings of prior devices in new and novel ways. In its most general sense, the present invention overcomes the shortcomings and limitations of the prior art in any of a number of generally effective configurations. The instant invention demonstrates such capabilities and overcomes many of the shortcomings of prior methods in new and novel ways.

The present invention is a method of making a custom environmentally friendly multilayer restroom fixture decorative device and the associated decorative device. In one embodiment of the instant invention, the method for making a custom environmentally friendly multilayer restroom fixture decorative device may begin by uploading a graphic to a computer system having a graphics modification system. After the graphic is uploaded to the computer system with a graphics modification system, the graphics modification system is utilized to create a modified graphic. Next, the modified graphic is transmitted to a cutting device. When the modified graphic has been transmitted to the cutting device, the cutting device cuts the modified graphic from a pliable graphic substrate to create an appliqué. Once the appliqué has been cut from the pliable graphic substrate, the appliqué is attached to a pliable backing substrate to form the custom environmentally friendly multilayer restroom fixture decorative device of the present invention.

The pliable backing substrate includes a porcelain attachment surface, an appliqué attachment surface, a backing substrate perimeter, and the porcelain attachment surface has a releasable urine-resistant adhesive layer to releasably attach the pliable backing substrate to a restroom fixture. In one embodiment of the instant invention, the pliable backing substrate and pliable graphic substrate are free of printing inks and solvents, thus making the decorative device environmentally friendly to use.

In another embodiment of the present invention, the method of making a custom environmentally friendly multilayer restroom fixture decorative device further includes the step of attaching a pliable appliqué protective substrate to at least a portion of the pliable backing substrate to form a liquid-tight seal around the appliqué. In still another embodiment of the present invention, the method of making a custom environmentally friendly multilayer restroom fixture decorative device includes the step of printing a display image on a display substrate and positioning the display substrate between the pliable backing substrate and the pliable appliqué protective substrate prior to the attachment of the pliable appliqué protective substrate to the pliable backing substrate. In yet another embodiment, the appliqué is created from a plurality of graphic substrate strips that cooperate to form a visual representation of the graphic. In one embodiment, the plurality of graphic substrate strips are aligned substantially parallel to an appliqué attachment axis of the restroom fixture. In another embodiment, the plurality of graphic substrate strips are aligned substantially orthogonal to the appliqué attachment axis.

The system of the instant invention enables a significant advance in the state of the art. The instant invention is, in addition, widely applicable to a large number of applications. Variations, modifications, alternatives, and alterations of the various preferred embodiments may be used alone or in combination with one another, as will become more readily apparent to those with skill in the art with reference to the following detailed description of the preferred embodiments and the accompanying figures and drawings.

### BRIEF DESCRIPTION OF THE DRAWINGS

Without limiting the scope of the present invention as claimed below and referring now to the drawings and figures:

FIG. 1 is a process schematic showing an embodiment of the method of making the custom environmentally friendly multilayer restroom fixture decorative device of the present invention;

FIG. 2 is a process schematic showing an embodiment of the method of making the custom environmentally friendly multilayer restroom fixture decorative device of the present invention;

FIG. 3 is a process schematic showing an embodiment of the method of making the custom environmentally friendly multilayer restroom fixture decorative device of the present invention;

FIG. 4 is a process schematic showing an embodiment of the method of making the custom environmentally friendly multilayer restroom fixture decorative device of the present invention;

FIG. 5 is a perspective view of an embodiment of the custom environmentally friendly multilayer restroom fixture decorative device attached to a restroom fixture, not to scale;

FIG. 6 is a cross-sectional view of the embodiment of the custom environmentally friendly multilayer restroom fixture decorative device taken along section line 4-4, not to scale;

FIG. 7 is a cross-sectional view of an embodiment of the custom environmentally friendly multilayer restroom fixture decorative device, not to scale;

FIG. 8 is a cross-sectional view of an embodiment of the custom environmentally friendly multilayer restroom fixture decorative device, not to scale;

FIG. 9 is a cross-sectional view of an embodiment of the custom environmentally friendly multilayer restroom fixture decorative device, not to scale;

FIG. 10 is an elevation view of an embodiment of the custom environmentally friendly multilayer restroom fixture decorative device, not to scale;

FIG. 11 is an elevation view of an embodiment of the custom environmentally friendly multilayer restroom fixture decorative device, not to scale; and

FIG. 12 is an elevation view of an embodiment of the custom environmentally friendly multilayer restroom fixture decorative device, not to scale.

### DETAILED DESCRIPTION OF THE INVENTION

The method of making a custom environmentally friendly restroom fixture decorative device (50), and the device (50) itself, of the instant invention enables a significant advance in the state of the art. The preferred embodiments of the device accomplish this by new and novel arrangements of elements and methods that are configured in unique and novel ways and which demonstrate previously unavailable but preferred and desirable capabilities. The detailed description set forth below in connection with the drawings is intended merely as a description of the presently preferred embodiments of the invention, and is not intended to represent the only form in which the present invention may be constructed or utilized. The description sets forth the designs, functions, means, and methods of implementing the invention in connection with the illustrated embodiments. It is to be understood, however, that the same or equivalent functions and features may be accomplished by different embodiments that are also intended to be encompassed within the spirit and scope of the invention.

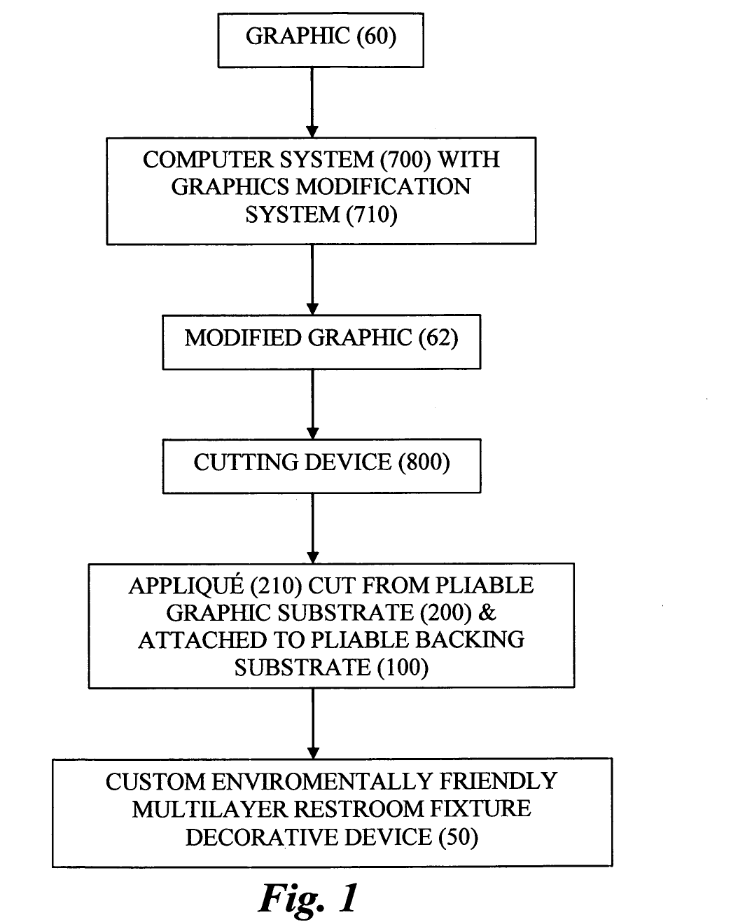

Referring now generally to FIGS. 1 through 12, the present invention is a method for making a custom environmentally friendly multilayer restroom fixture decorative device (50) and the resulting custom environmentally friendly multilayer restroom fixture decorative device (50). The method may generally be described as: first, uploading a graphic (60) to a computer system (700) with a graphics modification system (710); next, modifying the graphic (60) to create a modified graphic (62); then, transmitting the modified graphic (62) to a cutting device (800); next, cutting the modified graphic (62) from a pliable graphic substrate (200) to create an appliqué (210); and finally, attaching the appliqué (210) to a pliable backing substrate (100). Now these steps will be described below in detail.

In one embodiment of the instant invention, the method for making a custom environmentally friendly multilayer restroom fixture decorative device (50) may begin by uploading a graphic (60) to a computer system (700) having a graphics modification system (710), as seen in FIG. 1. By way of example and not limitation, the graphic (60) may be letters, numbers, symbols, pictures, logos, or combinations thereof. The graphic (60) may be uploaded to the computer system (700) in any of a number of ways which are readily apparent to those having skill in the art, such as by scanning the graphic (60) and saving the resulting file, or by uploading the graphic (60) from a storable media to the computer system (700). The computer system (700) may be any type of general-purpose computer capable of operating the graphics modification system (710), for example a personal computer.

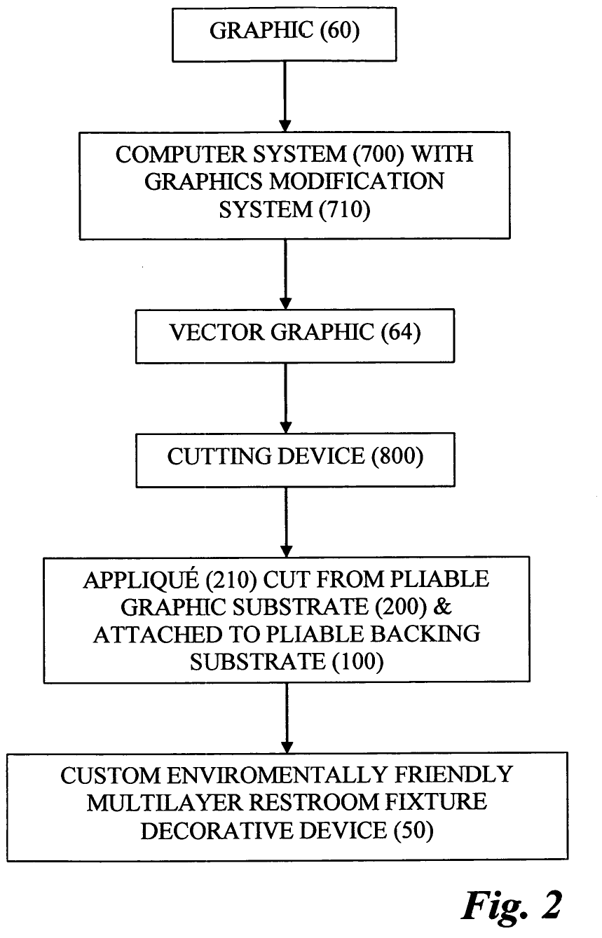

Still referring to FIG. 1, once the graphic (60) is uploaded to the computer system (700) having a graphics modification system (710), the graphics modification system (710) is utilized to create a modified graphic (62). The graphics modification system (710) may be any of a number of commercially available graphics or sign making software packages, such as Scanvec Amiable FlexiSign, Gerber Omega, Project5 Photocut Processor, DahediSign, CADlink Signlab, CorelDRAW, or Adobe Illustrator, just to name a few. One modification feature these types of programs have in common is the ability to convert a raster image to a vector image, sometimes referred to as vectorizing. Raster images, or bitmap images, consist of colored pixels in a grid, while vector images are made up of many individual, scaleable objects that are defined by mathematical equations rather than pixels. In one embodiment of the present invention, the graphics modification system (710) is used to modify the original graphic (60) to a vector graphic (64), as seen in FIG. 2.

With continued reference to FIG. 1, after the graphic (60) has been modified, the modified graphic (62) is transmitted to a cutting device (800). The cutting device (800) may be any commercially available plotter or cutter such as those from Graphtec USA, Roland, Mimaki, Summa, Mutoh and Gerber, just to name a few. The computer system (700) is connected to and transmits data to the cutting device (800) in the usual fashion, such as by a USB, wireless, serial or parallel connection. Depending on the particular graphics modification system (710) chosen, a stand-alone driver program, such as Amiable FlexiCut, CADlink ShortCut, and Roland SignMate Cut, just to name a few, or a basic driver compatible with the computer system (700) and graphics modification system (710) may be needed to transmit the data containing the modified graphic (62) to the cutting device (800). Currently, the state of the art is such that raster images are not capable of being cut with commercially available plotters or cutters, and thus, vector images must be used.

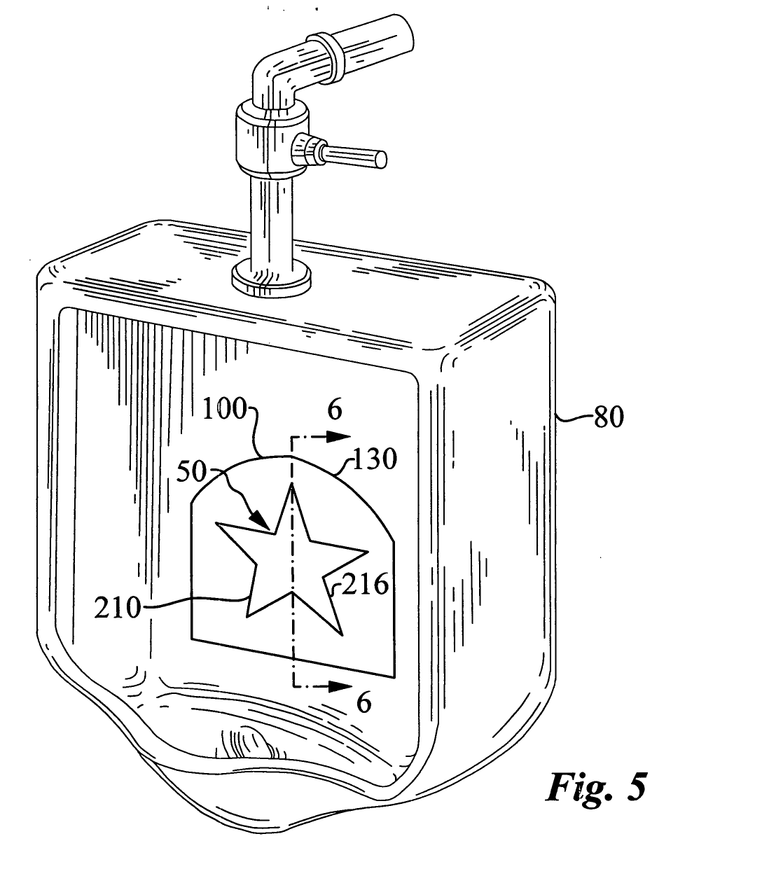

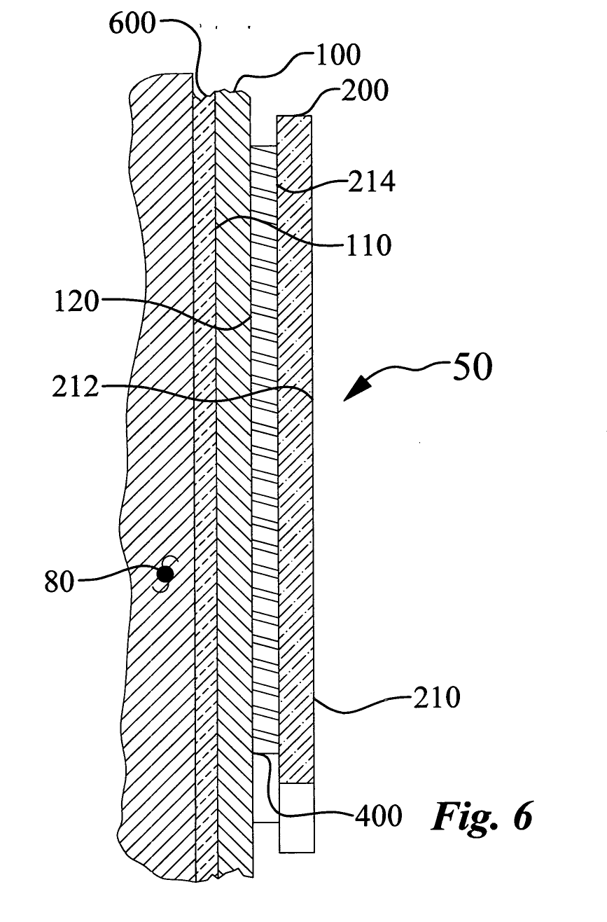

Still referring to FIG. 1, once the modified graphic (62) has been transmitted to the cutting device (800), the cutting device (800) cuts the modified graphic (62) from a pliable graphic substrate (200) to create an appliqué (210). The appliqué (210) is defined by a display surface (212), a mounting surface (214), and an appliqué perimeter (216), as seen in FIGS. 5 and 6. The pliable graphic substrate (200) may be chosen from a variety of materials including, but not limited to: vinyl polymers and copolymers, such as polyvinyl chloride, polyvinyl fluoride, polystyrene, and the like; polyolefins, such as polyethylene and polypropylene; fluoropolymers; polyamides; polyesters; acrylate polymers; and various other types of pliable thermoplastic materials which are well known in the art. The pliable graphic substrate (200) generally has a thickness of approximately 1 millimeter to approximately 3 millimeters. In one embodiment of the present invention, the pliable graphic substrate (200) used to create the appliqué (210) is free of printing inks and solvents. Using printing inks and solvents to create an appliqué (210) can have harmful effects on the environment. For example, if printing inks and solvents are used on the pliable graphic substrate (200), then it is likely that the sanitary system may become polluted with inks and solvents due to prolonged exposure to water and urine. Therefore, using a pliable graphic substrate (200) that is free of printing inks and solvents eliminates the potential risk posed to the environment associated with these inks and solvents.

With continued reference to FIG. 1, once the appliqué (210) has been cut from the pliable graphic substrate (200), the appliqué (210) is attached to a pliable backing substrate (100) to form the custom environmentally friendly multilayer restroom fixture decorative device (50) of the present invention, as seen in FIG. 6. The appliqué (210) may be attached to the pliable backing substrate (100) using a variety of materials and methods including, but not limited to, pressure sensitive adhesives, glues, fusion bonding, chemical welding, and mechanical fasteners. The pliable backing substrate (100) includes a porcelain attachment surface (110), an appliqué attachment surface (120), a backing substrate perimeter (130), and the porcelain attachment surface (110) has a releasable urine-resistant adhesive layer (600) to releasably attach the pliable backing substrate (100) to the interior of a restroom fixture (80), as seen in FIGS. 5 and 6. As seen in FIG. 5, the backing substrate perimeter (130) is configured such that the appliqué perimeter (216) lies entirely within the backing substrate perimeter (130). The pliable backing substrate (100) may be made of the same materials listed above for the pliable graphic substrate (200). The pliable backing substrate (100) generally has a thickness of approximately 1 millimeter to approximately 3 millimeters. In one embodiment of the instant invention, the pliable backing substrate (100) is free of printing inks and solvents, thus making it environmentally friendly to use. In another embodiment of the instant invention, the pliable backing substrate (100) is substantially transparent. The transparency of the pliable backing substrate is desirable so that the pliable backing substrate (100) does not detract from the appearance of the appliqué (210) allowing the appliqué (210) to contrast sharply with the interior of the restroom fixture (80).

In one embodiment of the instant invention, the appliqué (210) is attached to the pliable backing substrate (100) by an appliqué attachment interlayer (400), as seen in FIG. 6. The appliqué attachment interlayer (400) may be created from a variety of materials including, but not limited to, pressure sensitive adhesives, glues, epoxies, double-sided tapes, and the like.

The releasable urine-resistant adhesive layer (600) is utilized to releasably attach the pliable backing substrate (100) to the restroom fixture (80), as seen in FIG. 6. The releasable urine-resistant adhesive layer (600) may be selected from any of a variety of adhesives including, but not limited to, low tack adhesives, silicone based adhesives, acrylic adhesives, neoprene based adhesives, and epoxy adhesives. These types of adhesives are well known in the art. However, since the releasable urine-resistant adhesive layer (600) is used to attach the pliable backing substrate (100) to a restroom fixture (80), the releasable urine-resistant adhesive layer (600) should be capable of creating a bond strong enough to withstand multiple flushings of the restroom fixture (80). Furthermore, the bond created between the releasable urine-resistant adhesive layer (600) and the restroom fixture (80) should be such that the custom environmentally friendly multilayer restroom fixture decorative device (50) is capable of being removed from the restroom fixture (80) as a single piece, leaving very little residue.

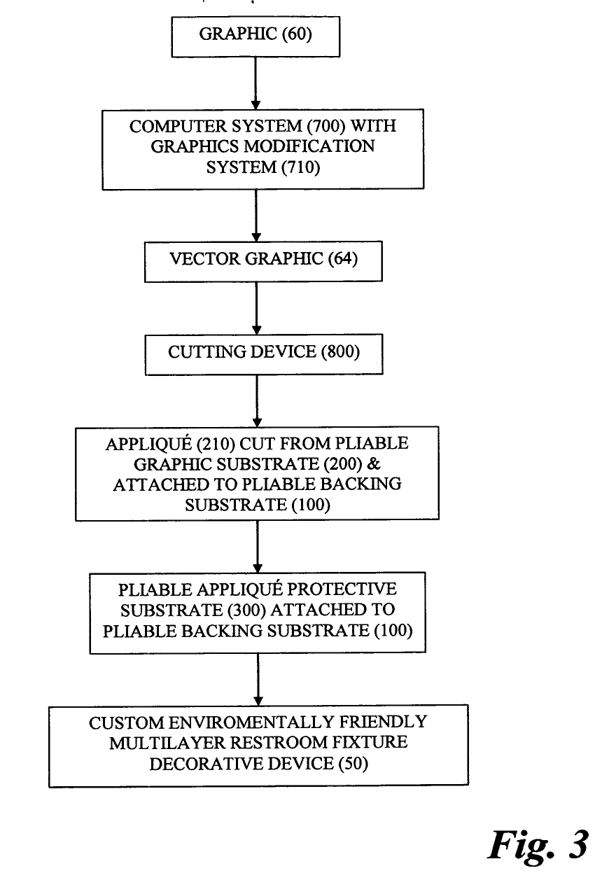

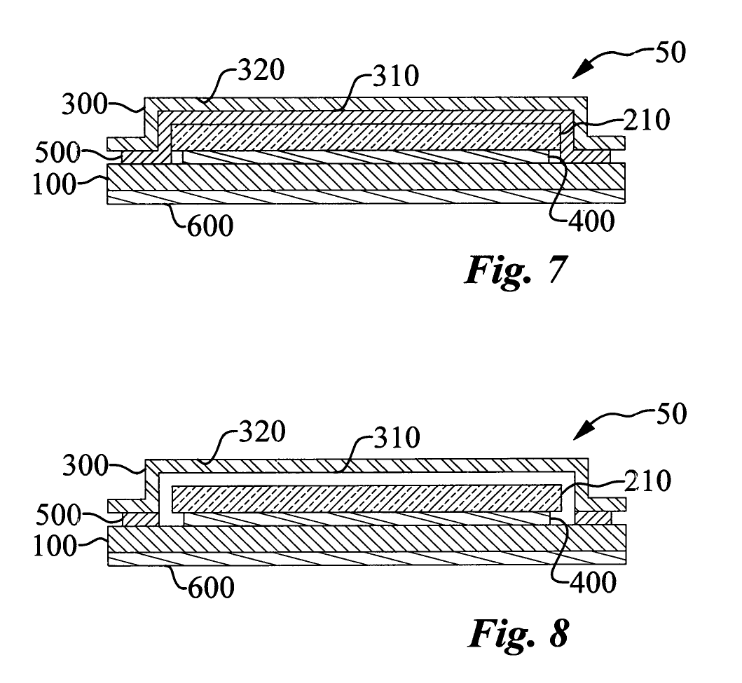

In one embodiment of the present invention, as seen in FIG. 3, the method of making a custom environmentally friendly multilayer restroom fixture decorative device (50) includes the step of attaching a pliable appliqué protective substrate (300) to at least a portion of the pliable backing substrate (100) to form a liquid-tight seal around the appliqué (210). The pliable appliqué protective substrate (300) may be attached to at least a portion of the pliable backing substrate (100) using a variety of materials and methods including, but not limited to, pressure sensitive adhesives, glues, fusion bonding, chemical welding, and mechanical fasteners. As seen generally in FIGS. 7 through 10, the pliable appliqué protective substrate (300) includes a sealing surface (310), a protective surface (320), and an appliqué protective substrate perimeter (330), wherein a portion of the sealing surface (310) is adjacent to a portion of the pliable backing substrate appliqué attachment surface (120) and the appliqué protective substrate perimeter (330) lies within the backing substrate perimeter (130). Furthermore, the appliqué protective substrate perimeter (330) is configured such that it completely covers the appliqué perimeter (216), thus allowing the appliqué (210) to be sealed between the appliqué protective substrate perimeter (330) and the pliable backing substrate (100). As with the pliable backing substrate (100), the pliable appliqué protective substrate (300) may be made of any of the materials suitable for use as the pliable graphic substrate (200) listed above. The pliable appliqué protective substrate (300) generally has a thickness of approximately 1 millimeter to approximately 3 millimeters. In one embodiment of the instant invention, the pliable appliqué protective substrate (300) is substantially transparent. The transparency of the pliable appliqué protective substrate (300) is desirable so that the pliable appliqué protective substrate (300) does not detract from the underlying substrates that are meant to be visible, such as an appliqué (210) or a display substrate (70).

In another embodiment of the instant invention, the attachment of the pliable appliqué protective substrate (300) to at least a portion of the pliable backing substrate (100) is achieved by an appliqué protective substrate attachment interlayer (500), as seen in FIGS. 7 and 8. In the embodiment shown in FIG. 7, the pliable appliqué protective substrate (300) is attached to the appliqué (210) by the appliqué protective substrate attachment interlayer (500), which thereby imparts greater stability of the appliqué (210) between the pliable appliqué protective substrate (300) and the pliable backing substrate (100). On the other hand, FIG. 8 shows an embodiment whereby a pocket is created between the pliable appliqué protective substrate (300) and the pliable backing substrate (100). The appliqué protective substrate attachment interlayer (500) may be created from a variety of materials including, but not limited to, pressure sensitive adhesives, glues, epoxies, double-sided tapes, and other types of materials capable of creating a liquid-tight seal.

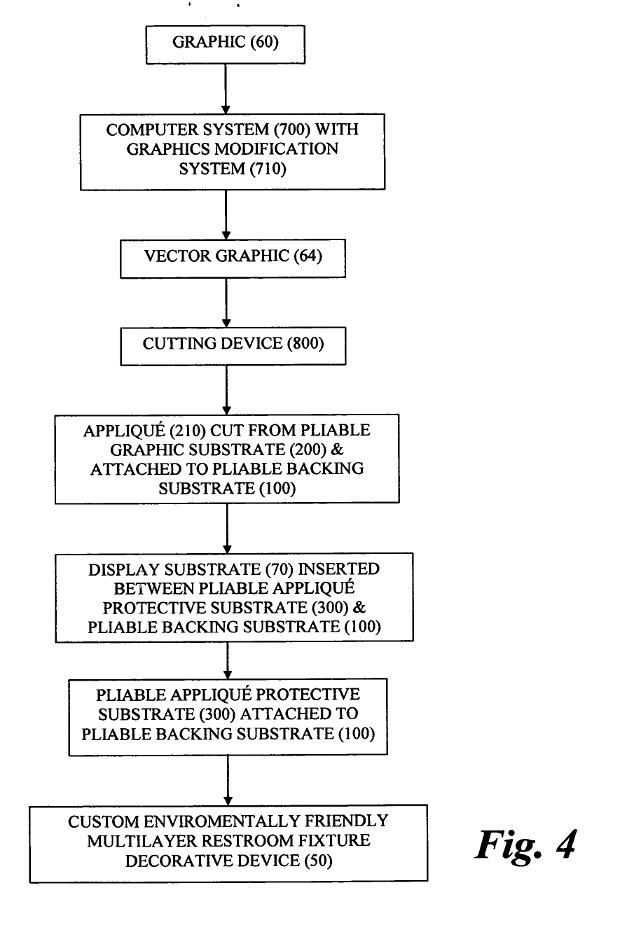

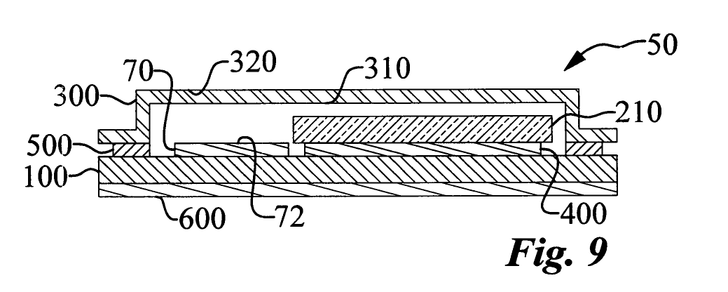

In another embodiment of the present invention, as seen in FIG. 4, the method of making a custom environmentally friendly multilayer restroom fixture decorative device (50) includes the step of printing a display image (72) on a display substrate (70) and positioning the display substrate (70) between the pliable backing substrate (100) and the pliable appliqué protective substrate (300) prior to the attachment of the pliable appliqué protective substrate (300) to the pliable backing substrate (100). This embodiment of the custom environmentally friendly multilayer restroom fixture decorative device (50) is seen in FIG. 9. The display image (72) may be any type of image, such as a photograph, logo, text, symbol, numerals, letters, and any combination thereof. The display substrate (70) may be any type of substrate suitable for printing upon including, but not limited to papers, olefins, vinyl polymers and copolymers, and transparency films. Furthermore, the display image (72) may be printed onto the display substrate (70) using various printing methods including, but not limited to, laser jet or inkjet printers, screen printing, and other printing methods that are well known in the art. Although in this embodiment the display substrate (70) will not be ink or solvent free, the decorative device (50) will still retain its environmentally friendly qualities due to the fact that the display substrate (70) is positioned within the liquid-tight seal created between the pliable appliqué protective substrate (300) and the pliable backing substrate (100). Thus, since the display substrate (70) is positioned behind a liquid-tight seal, any chance that the printing inks and solvents will pollute the sanitary waste systems is practically eliminated.

In one embodiment, as seen in FIG. 5, the custom environmentally friendly multilayer restroom fixture decorative device (50) is shown attached to a restroom fixture (80). Although the restroom fixture (80) depicted is a urinal, other types of restroom fixtures (80) may be used, such as toilets, sinks, and the like. As seen in FIG. 6, the custom environmentally friendly multilayer restroom fixture decorative device (50) is releasably attached to the restroom fixture (80) by the releasable urine-resistant adhesive layer (600), previously described. In this embodiment of the instant invention, the appliqué (210) is created from a continuous undivided portion of the pliable graphic substrate (200), here represented by a star shape, as seen in FIG. 5. A continuous undivided portion of pliable graphic substrate (200) results in an appliqué (210) that is an outline representation of the graphic (60). Referring now to FIG. 6, the pliable graphic substrate (200) of this embodiment is a solid homogeneous sheet. Using a solid homogeneous sheet of pliable graphic substrate (200) gives the appliqué (210) a uniform thickness throughout its cross-section. The features of this embodiment may be used for creating appliqués (210) that show an outline representation of a graphic (60), such as a silhouette, profile, or various other shapes and designs.

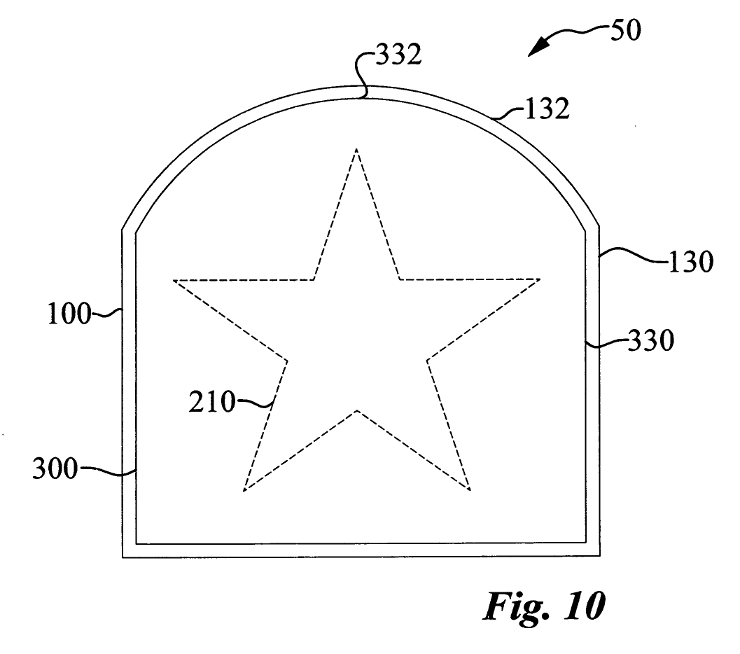

Another embodiment of the custom environmentally friendly multilayer restroom fixture decorative device (50) is shown in FIG. 10. In this embodiment, the backing substrate perimeter (130) includes a backing substrate liquid drainage contour (132). Likewise, the appliqué protective substrate perimeter (330) includes an appliqué protective substrate liquid drainage contour (332). These drainage contours (132, 332) prevent liquid from pooling along the backing substrate and appliqué protective substrate perimeters (130, 330). The drainage contours (132, 332) may be any shape that would promote drainage of liquid along the perimeters (130, 330). This feature promotes a more sanitary decorative device (50) by preventing harmful bacteria and other microorganisms that could develop as a result of a stagnant mixture of urine and water pooling along the backing substrate and appliqué protective substrate perimeters (130, 330).

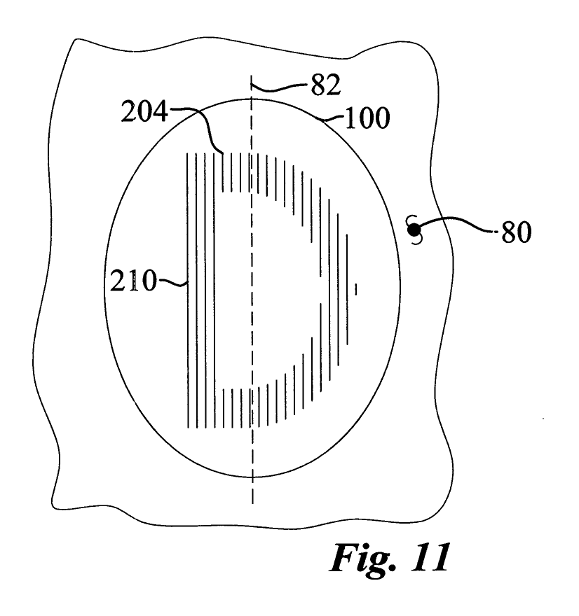

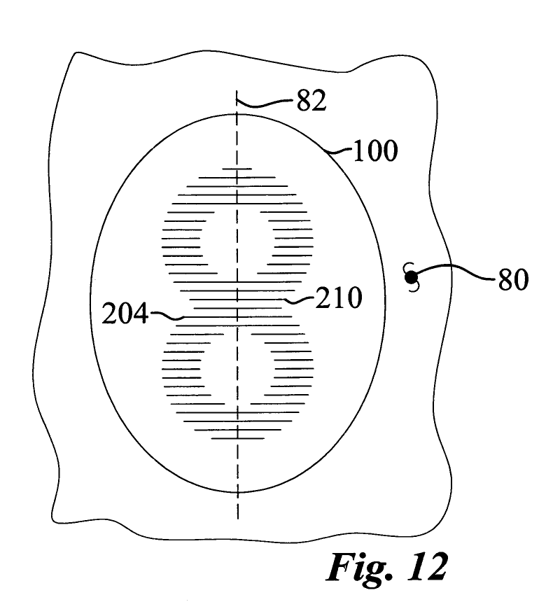

Turning now to FIGS. 11 and 12, embodiments of the custom environmentally friendly multilayer restroom fixture decorative device (50) are disclosed wherein the appliqué (210) is created from a plurality of graphic substrate strips (204) that cooperate to form a visual representation of the graphic (60). In one embodiment, seen in FIG. 11, the plurality of graphic substrate strips (204) are aligned substantially parallel to an appliqué attachment axis (82) of the restroom fixture (80). The appliqué attachment axis (82) is an imaginary line or plane that represents the direction of water flow in the restroom fixture (80). In the embodiment shown in FIG. 11, the alignment of the graphic substrate strips (204) is such that channels between the strips (204) are created in the direction of water flow. Thus, the channels promote water flow over the custom environmentally friendly multilayer restroom fixture decorative device (50). In another embodiment, seen in FIG. 12, the plurality of graphic substrate strips (204) are aligned substantially orthogonal to the appliqué attachment axis (82). This type of alignment of the graphic substrate strips (204) creates a series of ridges which the flowing water must overcome. Thus, the ridges promote a cascading type of water flow over the plurality of graphic substrate strips (204). Although FIGS. 11 and 12 show the graphic substrate strips (204) as single lines, they generally have a width of approximately 1 millimeter to approximately 6 millimeters.

Embodiments of the custom environmentally friendly multilayer restroom fixture decorative device (50) wherein the appliqué (210) is created from a plurality of graphic substrate strips (204), as seen in FIGS. 11 and 12, are created using the same methods as described above. Furthermore, using the methods described above, appliqués (210) may be created that are accurate reproductions of photographic images. However, to produce such appliqués (210), a graphics modification system (710) that can vectorize bitmap images must be utilized, such as Project5 Photocut Processor or DahediSign. The result of using this type of graphics modification system (710) is a vector graphic (64) of the photographic image, represented by variable width strips. The cutting device (800) is then utilized to cut variable width strips from the pliable graphic substrate (200) to create the appliqué (210). It should be noted that the variable width strips are not applied one strip at a time to create the appliqué (210); rather, the variable width strips remain attached to the pliable graphic substrate (200) and the parts of the pliable graphic substrate (200) that do not comprise the appliqué (210) are weeded from the appliqué (210) and discarded after the appliqué (210) is attached to the pliable backing substrate (100).

While the method of making the custom environmentally friendly multilayer restroom fixture decorative device (50) may generally begin by manually uploading a graphic (60) to a computer system (700), it is contemplated that an automated uploading process may be used. For example, the step of uploading the graphic (60) may occur over the internet through a vendor's customer driven website. The graphic (60) would be received by the vendor's computer system (700) and the remaining steps to produce the custom environmentally friendly multilayer restroom fixture decorative device (50) would be performed.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

I claim:

1. A method of making a custom environmentally friendly multilayer restroom fixture decorative device (50), comprising the steps of:
(i) uploading a graphic (60) to a computer system (700) having a graphics modification system (710);
(ii) modifying the graphic (60) with the graphics modification system (710) to create a modified graphic (62);
(iii) transmitting the modified graphic (62) to a cutting device (800);
(iv) cutting the modified graphic (62) from a pliable graphic substrate (200) to create an appliqué (210), wherein the appliqué (210) includes a display surface (212), a mounting surface (214), and an appliqué perimeter (216); and
(v) attaching the appliqué (210) to a pliable backing substrate (100), wherein the pliable backing substrate (100) includes a porcelain attachment surface (110), an appliqué attachment surface (120), a backing substrate perimeter (130), and the porcelain attachment surface (110) has a releasable urine-resistant adhesive layer (400) to releasably attach the pliable backing substrate (100) to a restroom fixture (80).

2. The method of making a custom environmentally friendly multilayer restroom fixture decorative device (50) as in claim 1, further including the step of attaching a pliable appliqué protective substrate (300) to the pliable backing substrate (100) thereby forming a liquid-tight seal around the appliqué (210), wherein the pliable appliqué protective substrate (300) includes a sealing surface (310), a protective surface (320), and an appliqué protective substrate perimeter (330).

3. The method of making a custom environmentally friendly multilayer restroom fixture decorative device (50) as in claim 2, further including the step of printing a display image (72) on a display substrate (70) and positioning the display substrate (70) between the pliable backing substrate (100) and the pliable appliqué protective substrate (300) prior to the attachment of the pliable appliqué protective substrate (300) to the pliable backing substrate (100).

4. The method of making a custom environmentally friendly multilayer restroom fixture decorative device (50) as in claim 1, wherein the backing substrate perimeter (130) includes a backing substrate liquid drainage contour (132) to prevent liquid from pooling along the backing substrate perimeter (130).

5. The method of making a custom environmentally friendly multilayer restroom fixture decorative device (50) as in claim 2, wherein the appliqué protective substrate perimeter (330) includes an appliqué protective substrate liquid drainage contour (332) to prevent liquid from pooling along the appliqué protective substrate perimeter (330).

6. The method of making a custom environmentally friendly multilayer restroom fixture decorative device (50) as in claim 1, wherein the modified graphic (62) is a vector graphic (64).

7. The method of making a custom environmentally friendly multilayer restroom fixture decorative device (50) as in claim 1, wherein the pliable backing substrate (100) is substantially transparent.

8. The method of making a custom environmentally friendly multilayer restroom fixture decorative device (50) as in claim 2, wherein the pliable appliqué protective substrate (300) is substantially transparent.

9. The method of making a custom environmentally friendly multilayer restroom fixture decorative device (50) as in claim 1, wherein the pliable backing substrate (100) and the pliable graphic substrate (200) are free of printing inks and solvents.

10. The method of making a custom environmentally friendly multilayer restroom fixture decorative device (50) as in claim 1, wherein the pliable graphic substrate (200) is a solid homogeneous sheet.

11. The method of making a custom environmentally friendly multilayer restroom fixture decorative device (50) as in claim 1, wherein the appliqué (210) is created from a continuous undivided portion of the pliable graphic substrate (200).

12. The method of making a custom environmentally friendly multilayer restroom fixture decorative device (50) as in claim 1, wherein the appliqué (210) is created from a plurality of graphic substrate strips (204) that cooperate to form a visual representation of the graphic (60).

13. The method of making a custom environmentally friendly multilayer restroom fixture decorative device (50) as in claim 12, wherein the plurality of graphic substrate strips (204) are substantially parallel to an appliqué attachment axis (82) of the restroom fixture (80).

14. The method of making a custom environmentally friendly multilayer restroom fixture decorative device (50) as in claim 12, wherein the plurality of graphic substrate strips (204) are substantially orthogonal to an appliqué attachment axis (82) of the restroom fixture (80).

15. The method of making a custom environmentally friendly multilayer restroom fixture decorative device (50) as in claim 1, wherein the step of attaching the appliqué (210) to the pliable backing substrate (100) is achieved by an appliqué attachment interlayer (400).

16. The method of making a custom environmentally friendly multilayer restroom fixture decorative device (50) as in claim 2, wherein the step of attaching the pliable appliqué protective substrate (300) to the pliable backing substrate (100) is achieved by an appliqué protective substrate attachment interlayer (500).

17. A method of making a custom environmentally friendly multilayer restroom fixture decorative device (50), comprising the steps of:
(i) uploading a graphic (60) to a computer system (700) having a graphics modification system (710);
(ii) modifying the graphic (60) with the graphics modification system (710) to create a vector graphic (64);
(iii) transmitting the vector graphic (64) to a cutting device (800);
(iv) cutting the vector graphic (64) from a pliable graphic substrate (200) to create an appliqué (210), wherein the pliable graphic substrate (200) is a solid homogeneous sheet and free of printing inks and solvents; and
(v) attaching the appliqué (210) to a pliable backing substrate (100), wherein the pliable backing substrate (100) is free of printing inks and solvents and includes a porcelain attachment surface (110), an appliqué attachment surface (120), a backing substrate perimeter (130), and the porcelain attachment surface (110) has a releasable urine-resistant adhesive layer (400) to releasably attach the pliable backing substrate (100) to a restroom fixture (80).

18. The method of making a custom environmentally friendly multilayer restroom fixture decorative device (50) as in claim 17, further including the step of attaching a pliable appliqué protective substrate (300) to the pliable backing substrate (100) thereby forming a liquid-tight seal around the appliqué (210), wherein the pliable appliqué protective substrate (300) includes a sealing surface (310), a protective surface (320), and an appliqué protective substrate perimeter (330).

19. The method of making a custom environmentally friendly multilayer restroom fixture decorative device (50) as in claim 18, further including the step of printing a display image (72) on a display substrate (70) and positioning the display substrate (70) between the pliable backing substrate (100) and the pliable appliqué protective substrate (300) prior to the attachment of the pliable appliqué protective substrate (300) to the pliable backing substrate (100).

20. The method of making a custom environmentally friendly multilayer restroom fixture decorative device (50) as in claim 17, wherein the appliqué (210) is created from a continuous undivided portion of the pliable graphic substrate (200).

21. The method of making a custom environmentally friendly multilayer restroom fixture decorative device (50) as in claim 17, wherein the appliqué (210) is created from a plurality of graphic substrate strips (204) that cooperate to form a visual representation of the graphic (60).

22. The method of making a custom environmentally friendly multilayer restroom fixture decorative device (50) as in claim 21, wherein the plurality of graphic substrate strips (204) are substantially parallel to an appliqué attachment axis (82) of the restroom fixture (80).

23. A method of making a custom environmentally friendly multilayer restroom fixture decorative device (50), comprising the steps of:
(i) uploading a graphic (60) to a computer system (700) having a graphics modification system (710);
(ii) modifying the graphic (60) with the graphics modification system (710) to create a vector graphic (64);
(iii) transmitting the vector graphic (64) to a cutting device (800);
(iv) cutting the vector graphic (64) from a pliable graphic substrate (200) such that an appliqué (210) is created from a plurality of graphic substrate strips (204) that cooperate to form a visual representation of the graphic (60), wherein the pliable graphic substrate (200) is a solid homogeneous sheet and free of printing inks and solvents; and
(v) attaching the appliqué (210) to a pliable backing substrate (100) such that the plurality of graphic substrate strips (204) comprising the appliqué (210) are substantially parallel to an appliqué attachment axis (82) of a restroom fixture (80), wherein the pliable backing substrate (100) is free of printing inks and solvents and includes a porcelain attachment surface (110), an appliqué attachment surface (120), a backing substrate perimeter (130), and the porcelain attachment surface (110) has a releasable urine-resistant adhesive layer (600) to releasably attach the pliable backing substrate (100) to the restroom fixture (80).
